(19) United States
(12) Patent Application Publication
(10) Pub. No.: US 2011/0278213 A1
(43) Pub. Date: Nov. 17, 2011

(54) SLOW FILTRATION DEVICE HAVING EXCELLENT ABILITY TO TREAT MICROORGANISMS

(76) Inventor: Toyofumi Miyazaki, Hyogo (JP)

(21) Appl. No.: 13/146,173

(22) PCT Filed: Apr. 30, 2009
(86) PCT No.: PCT/JP2009/058446

§ 371 Date: Jul. 25, 2011

(51) Int. Cl. B01D 35/18

(52) U.S. Cl. 210/175

(57) ABSTRACT

There is provided a slow filtration device adapted so that raw water sampled from a river or out of the ground can be treated into drinkable water, etc. in a short time after being newly assembled. The slow filtration device including a filtration sand layer, a raw-water supply part, and a removal part includes a net (15) provided above a filtration sand layer (13) within the filtration tank (11) so as to cover the filtration sand layer (13) and used as a carrier for the breeding of algae, a heat-generating heater (18) provided directly below the net (15) to maintain the net (15) at a predetermined temperature, and an algae raising lamp (16) provided above the net (15) within the filtration tank (11) to radiate light onto the net (15) and promote growth of the algae.

### TECHNICAL FIELD

The present invention relates to a slow filtration device having ability excellent to treat microorganisms, and particularly, to the device adapted to be able to raise and breed microorganisms in a short period of time after being newly assembled, and treat the water (hereinafter referred to as “raw water”) sampled from a river or out of the ground into drinkable water, etc.

### BACKGROUND ART

Generally, a slow filtration method and a rapid filtration method are known as the method of producing drinkable water from raw water. The slow filtration method is a method of microorganism-treating raw water by a filtration sand layer and filtering foreign substances to purify the water. This method is slow in treatment speed as compared with the rapid filtration method for processing raw water using chemicals, such as chlorine, but is excellent for drinkable water in that there is little chemical smell (Patent Literature No. 1, No. 2, No. 3, No. 4, & No. 5).

In this slow filtration device, in a case where the device is newly assembled and started to run, there is a possibility that purifying treatment of raw water becomes insufficient if the device is not operated after microorganisms are generated, stabilized and propagated in the filtration sand layer.

### CITATION LISTS

### Patent Literature

PLT 1 JP-A-07-308518
PLT 2 JP-A-2001-25611
PLT 3 JP-A-2003-275782
PLT 4 JP-A-2005-211804
PLT 5 JP-A-2003-24717

### SUMMARY OF INVENTION

### Technical Problem

However, since the generation, stabilization, and propagation of microorganisms are abandoned to nature, substantial time is required until the device is operated after being newly set.

The invention was made in view of such problems, and the object thereof is to provide a slow filtration device adapted so that microorganisms can be raised and bred in a short time after the device is newly set, and raw water can be rapidly purified.

### Solution to Problem

The slow filtration device having excellent ability to treat microorganisms according to the invention includes a filtration sand layer provided within a filtration tank to treat raw water with microorganisms and filter foreign substances, a raw-water supply part provided above the filtration sand layer to receive the raw water and supply the raw water to the filtration sand layer, and a removal part provided below the filtration sand layer to take out filtered water. The slow filtration device includes a net provided above the filtration sand layer within the filtration tank to cover the filtration sand layer, and used as a carrier for the raising and breeding of algae; a heat-generating heater provided directly below the net to maintain the net at a predetermined temperature; and an algae raising lamp provided above the net within the filtration tank to radiate light onto the algae on the net to promote the growth and breeding of the algae.

One of the features of the invention is to provide the net above the filtration sand layer, maintain the net at a predetermined temperature by the heat-generating heater, and radiate light resembling solar light from above the net by the algae raising lamp so that the growth of algae is promoted, thereby algae are generated, stabilized and bred in the net.

Thereby, an environment where microorganisms are generated, stabilized and propagated can be quickly formed, the operation can be rapidly started if the slow filtration device is started to run and it is not necessary to stand by for a substantial period of time. According to the experiment of the present inventor, in a conventional slow filtration device, about one month was required until the device could be operated after being newly assembled. However, in the slow filtration device according to the invention, it was confirmed that the device could be operated within about 10 days.

Light and temperature are required for the generating and breeding of algae in an early stage. Then, the algae raising lamp is provided so as to radiate light, specifically, light similar to the characteristics of solar light. Thereby, the growth and breeding of algae are promoted, the gap between the net with the algae and the surface layer of the lower filtration sand layer becomes a habitat of microorganisms. As a result, raw water is efficiently treated by microorganisms, impurities which suspends in the raw water are entangled in the algae, and then raw water from which impurities are separated is sent to the lower filtration sand layer. In the filtration sand layer, impurities are further separated, and are subjected to microorganism treatment by a microorganism film formed in the filtration sand layer.

For example, an artificial solar floodlight with a radiation wavelength region of 300 nm to 780 nm can be used as the algae raising lamp. Although the algae raising lamp may be turned on at certain intervals, since a device for on/off control is needed, which results in a cost increase, it is desirable to turn on the lamp continuously for 24 hours.

Additionally, since the heat-generating heater is provided directly below the net (for example, in the surface of the filtration sand layer) so that the surface layer is maintained at a preferred temperature (for example, 20° C. to 30° C.), microorganisms can be stably raised and propagated. The heat-generating heater may be energized at certain intervals to generate heat or may be made to generate heat continuously for 24 hours.

As described above, when microorganisms are efficiently raised and propagated, there is a possibility that a large amount of excess sludge or filtrate (impurities or residue after the treatment) may be generated in a short period of time and clogging may be caused to deteriorate the filtration speed of raw water. Therefore, it is necessary to remove the sludge.

In the conventional slow filtration device, disassembling the device to shave off the surface layer of the filtration sand layer, or separating sludge from the filtration sand layer by using the reverse cleaning water and draining the raw water with which sludge is mixed is performed. However, not only is the operation complicated, but substantial time is required.

Thus, when the excess sludge and filtrate which have been gushed up by the reverse cleaning water are sucked and discharged out of the system by arraying a plurality of suction nozzles directly above the filtration sand layer and moving the suction nozzles along the surface layer, the excess sludge and filtrate can be automatically and rapidly removed.

That is, it is desirable that the slow filtration device further includes a reverse cleaning nozzle provided at the bottom of the filtration tank to pump reverse cleaning water towards the filtration sand layer to allow excess sludge and filtrate adhered to the filtration sand layer and the net to gush up, a sludge discharge device which sucks the excess sludge and filtrate which have gushed up by a plurality of suction nozzles and discharges the excess sludge and filtrate from discharge passages, and a driving mechanism which moves the suction nozzles along the surface of the net directly above the net.

Algae are raised and bred in the net in a short period of time by radiation of the algae raising lamp and microorganisms are propagated. Thus, when raw water is aerated, oxidization of iron which is dissolved in raw water is promoted, odor materials can be removed, the activity of aerobic microorganisms is promoted by the dissolved oxygen in raw water, and organic matters, iron, manganese, and ammonia nitrogen can be efficiently removed.

Although an aeration device may be a type in which air is blown in, it is desirable to supply raw water into which air is blown, in promoting dissolving of oxygen. That is, it is desirable that the slow filtration device further includes an aeration pipe attached to the filtration tank, and blowing raw water containing air into the raw-water supply part to aerate the raw water.

The driving mechanism can adopt the following structure. If the filtration tank has a cylindrical shape, the driving mechanism can be adapted such that a rotary shaft is provided at the center of the filtration tank so as to vertically extend, the plurality of suction nozzles is attached to a horizontal arm at intervals in a longitudinal direction, a base of the horizontal arm is fixed to the rotary shaft, and the rotary shaft is rotated by a driving source.

Additionally, if the filtration tank has a quadrangular box shape, the driving mechanism can include a first rail provided horizontally above the filtration tank, a second rail horizontally supported by the first rail so as to be slidable along the first rail and extending in a direction orthogonal to the first rail and a draining pipe supported by the second rail so as to be slidable along the second rail, extending vertically downward and having suction nozzles attached to a lower end thereof.

Preferably, the net has fine openings. This is because, if the openings are excessively large, meshes of algae which have been bred become too large, impurities pass through the meshes of algae, and raw water which flows to the filtration sand layer increases without coming into contact with microorganisms of algae. On the other hand, if the openings are too small, clogging becomes apt to occur. Specifically, it is preferable that the net has openings within a range of 0.053 mm to 0.283 mm.

Although the net material may be any material on which algae can be carried, if the influence on drinkable water is taken into consideration, it is desirable to adopt stainless steel, for example, metal net made of SUS 305.

Well-known structures can be adopted as the structure of the filtration sand layer. The filtration sand layer can include, for example, a first fine burnt sand layer with a mean diameter of 0.08 mm to 0.3 mm, a second minute sand layer with a mean diameter of 0.4 mm to 1.8 mm provided below the first fine burnt sand layer, and a third gravel layer with a mean diameter of 2 mm to 20 mm and a cobble layer provided below the second minute sand layer. Burnt sand is used in order to remove in advance organic impurities, germs, and other impurities which adhere to mountain sand, river sand, and sea sand, and to obtain cleaning turbidity superior to a prescribed turbidity, i.e., 30 degrees, in the filtration sand layer.

### BRIEF DESCRIPTION OF DRAWINGS

FIG. 1 is a schematic configuration view showing a preferred embodiment of a slow filtration device of the invention.

FIG. 2A is a view showing a state where algae are raised and bred in the above embodiment, FIG. 2B is a view showing a state where microorganisms are stabilized, and foreign substances are captured, and FIG. 2C is a view showing a state where excess sludge and filtrate are being sucked.

FIG. 3 is a view showing the operating state of a horizontal arm and a suction nozzle in the above embodiment.

FIG. 4 is a view showing an example of the structure of an aeration pipe in the above embodiment.

FIG. 5 is a view showing an example of the structure of a filtration sand layer in the above embodiment.

FIG. 6 is a view showing a second embodiment.

### DESCRIPTION OF EMBODIMENTS

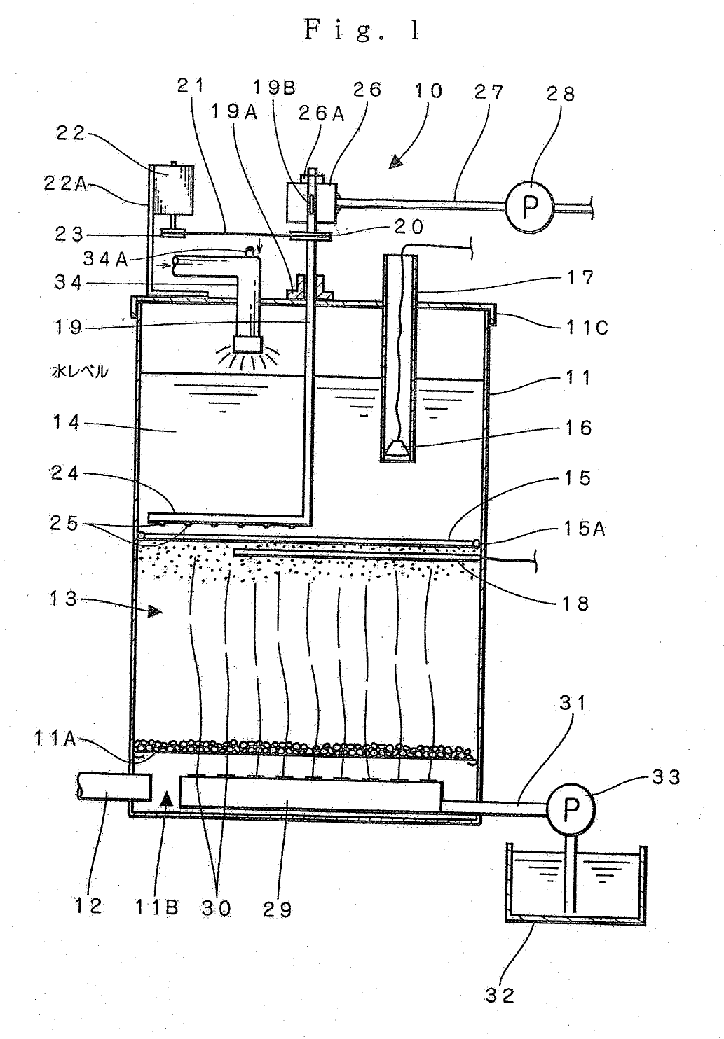

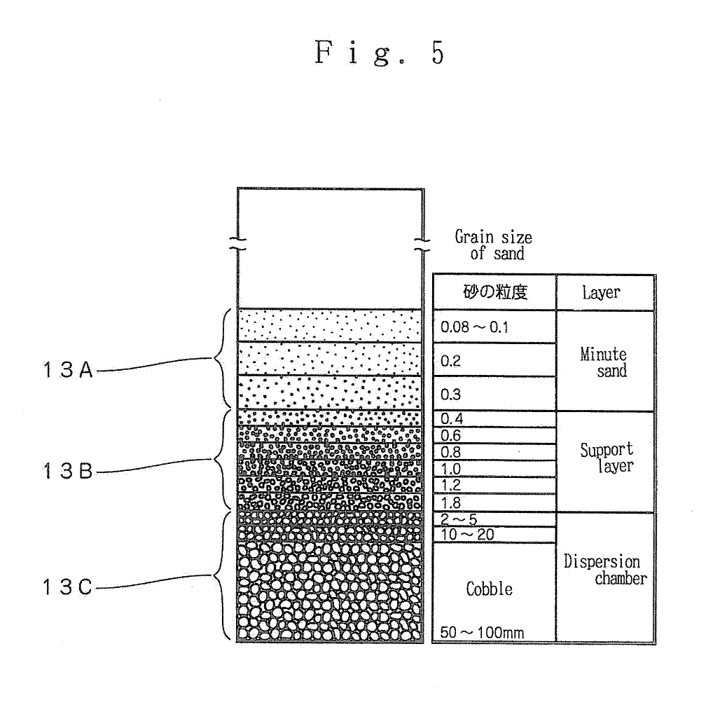

FIGS. 1 to 5 show a preferable embodiment of a slow filtration device having excellent ability to treat microorganism according to the invention. In the drawings, the slow filtration device 10 includes a bottomed cylinder water purifying container (filtration tank) 11, a top opening of the purifying container 11 is blocked by a lid 11C, a space 11B for filtered water is partitioned at the bottom of the water purifying container 11 by a perforated panel (or net) 11A, and a removal pipe 12 through which filtered water (drinkable water) is removed from the system is connected in communication with a tank wall which faces the space 11B for filtered water.

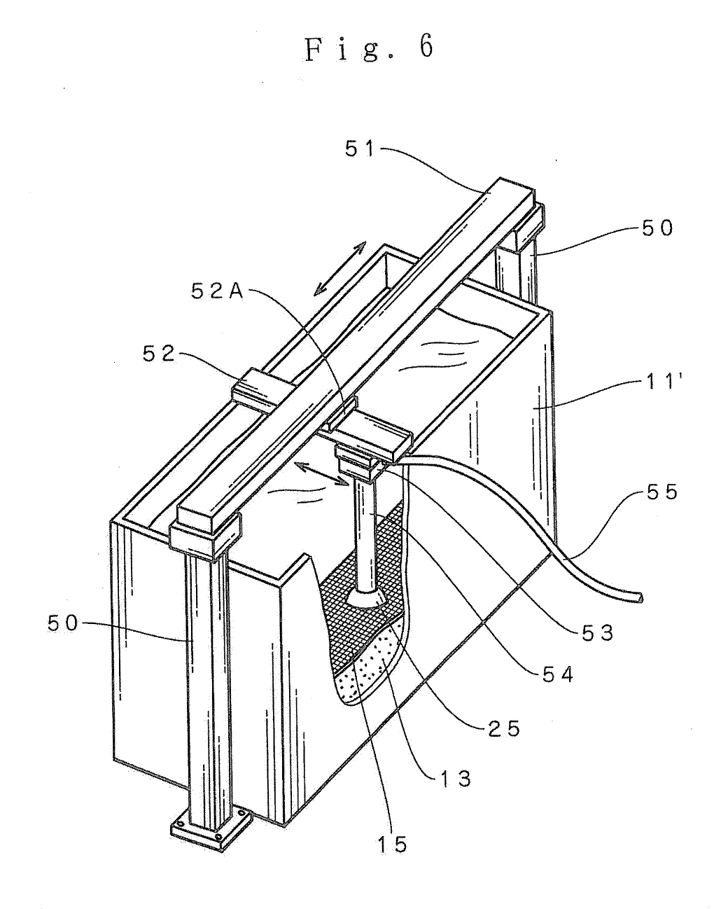

A filtration sand layer 13 is provided above the partition plate (or net) 11A within the purifying container 10 so that raw water is subjected to microorganism treatment and impurities are filtered therethrough. For example, particle size distribution as shown in FIG. 5 is adopted in this filtration sand layer 13. The filtration sand layer includes, for example, a first fine burnt sand layer 13A with a mean diameter of 0.08 mm to 0.3 mm, a second minute burnt sand layer 13B with a mean diameter of 0.4 mm to 1.8 mm provided below the first fine burnt sand layer 13A and a third gravel layer with a mean diameter of 2 mm to 20 mm and a cobble layer 130 provided below the second minute burnt sand layer 13B. In addition, the side surface of the filtration sand layer 13 may have direct contact with the tank wall, and the side surface of the filtration sand layer 13 may be covered with a filter cloth, for example, silk cloth.

A raw-water supply part 14 is provided above the filtration sand layer 13, and the raw-water supply part 14 is adapted to receive raw water and supply the raw water towards the filtration sand layer 13.

A net 15 used as a carrier for raising and breeding algae is provided directly above the filtration sand layer 13 within the purifying container 11 so as to cover the surface of the filtration sand layer 13. The net 15 is made as a metal net with 200 meshes, i.e., an opening of 0.076 mm, using a stainless steel wire with a wire diameter of 0.051 mm. The periphery of the net 15 is fixed to an annular frame 15A, and the frame 15A is brought into close contact with and held by the inner wall surface of the purifying container 11.

A cylindrical light set pole 17 is attached to the lid 11C of the purifying container 11, the bottom surface of the light set pole 17 is formed of a transparent material, for example, transparent glass, the algae raising lamp 16 is built in the vicinity of the bottom surface within the light set pole 17 and is located above the net 15 within the purifying container 11 so as to radiate light on the algae of the net 15, and promote the growth and breeding of the algae.

A heat-generating heater 18 with a sensor is buried directly below the net 15 in the surface layer of the filtration sand layer 13 so as to maintain the surface layer of the filtration sand layer 13 and the net 15 at a certain temperature.

Additionally, a bearing 19A is attached to the center of the lid 11C of the purifying container 11, a pipe-shaped rotary shaft 19 extends downward and is attached to the bearing 19A, a transmission pulley 20 is fixed to an upper portion of the rotary shaft 19, the transmission pulley 20 is coupled with a driving pulley 23 of a driving motor 22 by a belt 21, and the driving motor 22 is attached to the lid 11C of the purifying container 11 by an attaching bracket 22A.

Additionally, a pipe-shaped horizontal arm 24 communicates with and is fixed to a lower end of the rotary shaft 19, a tip of the horizontal arm 24 is closed, and a plurality of suction nozzles 25 is provided at intervals in the horizontal arm 24 and communicates with and is attached to the inside of the horizontal arm 24.

An upper end of the rotary shaft 19 is closed, and the upper end of the rotary shaft 19 is inserted through an insertion hole of a sealed box 26 and is retained by a retaining ring 26A. A seal ring (not shown) is interposed between the sealed box 26 and the rotary shaft 19. A discharge port 19B is formed in the rotary shaft 19 and communicates with the inside of the sealed box 26. A discharge pipe (discharge passage) 27 communicates with and is connected to the sealed box 26. A pump 28 is connected to the middle of a draining pipe 27.

Meanwhile, a flat reverse cleaning box 29 is arranged within the space 11B for filtered water of the purifying container 11 so as to substantially cover the bottom surface of the purifying container 11, reverse cleaning nozzles 30 are provided at the positions of lattice points in the reverse cleaning box 29, a reverse cleaning pipe 31 is connected to the reverse cleaning box 29, the tip of the reverse cleaning pipe 31 reaches a storage tank 32 for reverse cleaning water, and a pump 33 is connected to the middle of the reverse cleaning pipe 31.

Additionally, an aeration pipe 34 is inserted into and attached to the lid 11C of the purifying container 11, a nozzle 34B is attached to the tip of the aeration pipe, an air pipe 34A is inserted into the aeration pipe 34, and the tip of the air pipe 34A faces a receiving portion of the nozzle 34B, a pump is connected to the upstream end of the aeration pipe 34 so that the air from the air pipe 34A is brought into collision with the receiving portion of the nozzle 34B, is mixed with the raw water which circulates through the aeration pipe 34, and is discharged from the hole of the nozzle 34B.

If the slow filtration device 10 of this example is newly assembled and operated, raw water is supplied to and stored in the raw-water supply part 14, the algae raising lamp 16 is turned on to continuously radiate light with characteristics resembling solar light towards the net 15 for 24 hours. Simultaneously, the surface layer of the filtration sand layer 13 and the net 15 are maintained at a certain temperature, for example, 20° C. to 30° C. by energizing the heat-generating heater 18. Then, since the temperature of the surface layer of the filtration sand layer 13 and the net 15 becomes a temperature suitable for the raising and breeding of the algae included in the raw water, the algae 40 adhere to the net 15, are raised and stabilized under the radiation of light, and bred in a short time (FIG. 2A).

When the algae 40 are bred, microorganisms 41 can be stabilized and can be bred rapidly, using the algae 40 as a habitat, and microorganisms are stabilized and bred even on the surface layer of the lower filtration sand layer 13 (FIG. 2B).

If the microorganisms 41 propagate in this way, the operation of the slow filtration device 10 is started. The operation is performed by supplying raw water into the raw-water supply part 14 so that raw water passes through the filtration sand layer 13 at a flow velocity of about 5 to 15 m/hr, and discharging filtered water from the removal pipe 12.

Additionally, the raw water including the air is supplied from the nozzle 34B of the aeration pipe 34, and oxygen is dissolved in the raw water. When raw water is sent toward the filtration sand layer 13, comparatively large foreign substances, for example, dust, insects, eggs, etc., which are included in the raw water, are entangled in the algae 40 of the net 15, and are removed. Simultaneously, the microorganisms settled in the algae 41 decompose organic impurities in the raw water. However, when the raw water is aerated as described above, oxidization of iron which is dissolved in the raw water is promoted, odor materials can be removed, the activity of aerobic microorganisms is promoted by the dissolved oxygen in the raw water, and organic matters, iron, manganese, and ammonia nitrogen can be efficiently removed.

The raw water which has been purified to some extent in this way is sent to the filtration sand layer 13, is filtered by the filtration sand layer 13, and is treated by the microorganisms of the filtration sand layer 13. By this treatment, for example, not only comparatively small foreign substances or organic sludge, but also protozoa, such as Cryptosporidium, Cyclospora, and Giardia, are removed, and filtered water is removed from the bottom of the purifying container 11 and the removal pipe 12 to outside the system.

In the slow filtration device 10 of this example, the environment where the algae 40 are bred is ready. Thus, on the net 15 and the surface layer of the filtration sand layer 13, withered algae, excess sludge, filtered foreign substances (filtrate) deposit in large quantities, clogging occurs, and the purifying speed of the raw water slows.

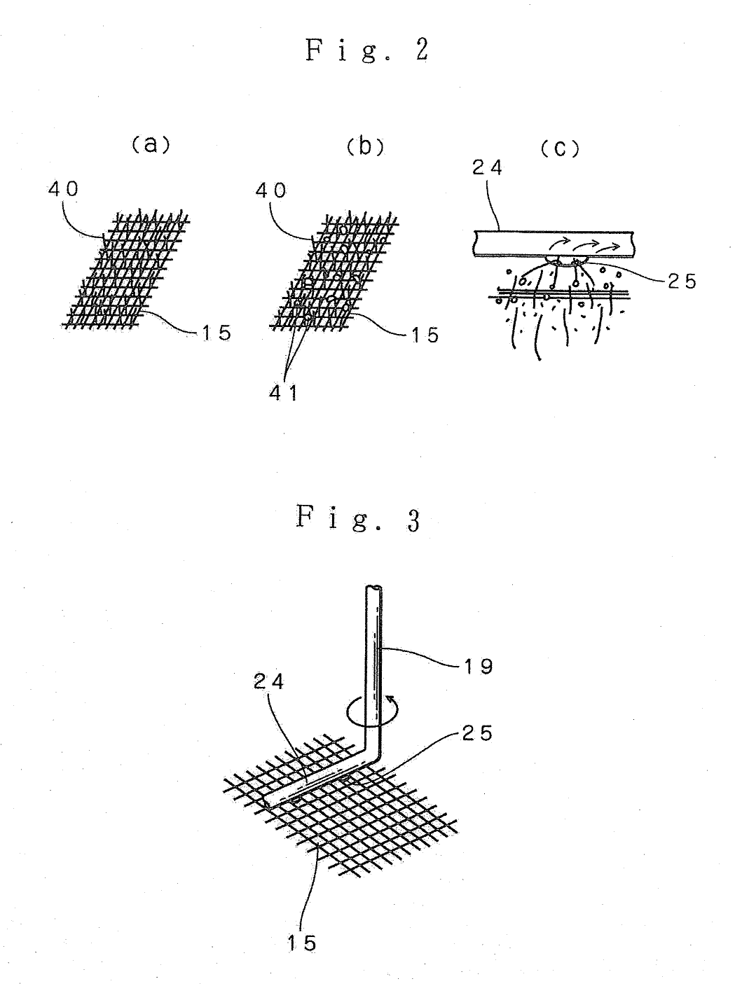

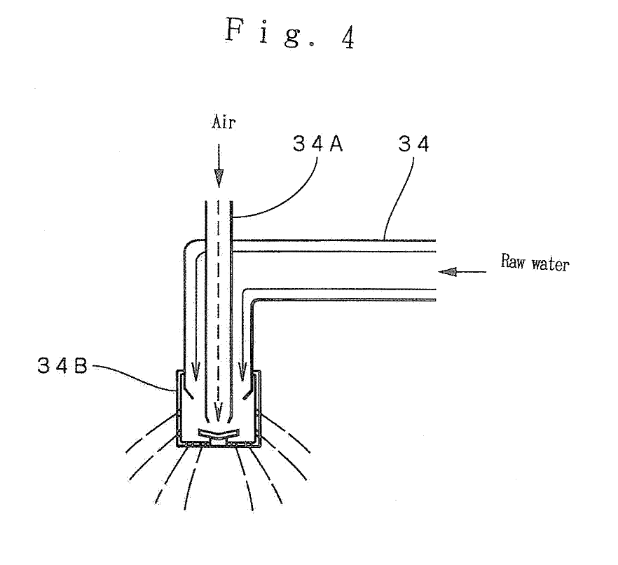

Thus, the pump 33 is operated, and the reverse cleaning water is pumped towards the filtration sand layer 13 from the reverse cleaning nozzles 30. Then, since the reverse cleaning water is gushed out of the surface of the filtration sand layer 13 through the filtration sand layer 13, and allows the excess sludge or filtrate which has adhered to the surface layer of the filtration sand layer 13 and the net 15 to gush up, the driving motor 22 is operated, the horizontal arm 24 is turned around the rotary shaft 19, and the pump 28 is operated, as shown in FIG. 2C and FIG. 3, the excess sludge and filtrate which have gushed up is sucked from the suction nozzles 25, and is sucked and discharged out of the system through the horizontal arm 24, the rotary shaft 19, the sealed box 26, and the discharge pipe 27. Then, the net 15 and the surface layer of the filtration sand layer 13 can be cleaned and reproduced.

The cleaning and reproduction of the net 15 and the filtration sand layer 13 may be confirmed by an operator's eye, and may be periodically (automatically) performed.

As described above, since the function as a filter by algae or microorganisms is provided before the microorganism treatment and filtering of foreign substances in the filtration sand layer 13, raw water can be efficiently purified over a long period of time, expendables, etc. are not needed, maintenance is also hardly required, and consequently, an inexpensive slow filtration device is obtained.

FIG. 6 is a view showing a second embodiment. In this example, a purifying container (filtration tank) 11′ has a quadrangular box shape, struts 50 are fixed to both sides of the purifying container 11′, a first rail 51 is laid between the upper ends of the struts 50, and a second rail 52 is supported by the first rail 51 so as to be slidable along the longitudinal direction of the first rail 51.

The second rail 52 extends in a direction orthogonal to the first rail 51, a base 53 of a discharge pipe 54 is supported by the second rail 52 so as to be slidable along the second rail 52, the discharge pipe 54 extends vertically downward, the suction nozzles 25 are connected to the lower end of the discharge pipe, and a discharge hose 55 is connected to the base 53 so that a suction is performed by a pump (not shown).

Additionally, driving mechanisms including a driving motor are built in a base 52A of the second rail 52 and the base 53 of the discharge pipe 54 to make the second rail 52 slide along the first rail 51 and make the discharge pipe 54 slide along the second rail 52 so that the excess sludge or filtrate which has gushed up from the surface layer of the filtration sand layer 13 and the net 15 can be sucked and removed by the reverse cleaning water.

In addition, the second embodiment is different from the first embodiment in that the purifying container 11′ has a quadrangular box shape, and excess sludge, etc. is discharged by the first and second rails 51 and 52, and the discharge pipe 54, and the filtration sand layer, the net, the algae raising lamp, the reverse cleaning box, and the reverse cleaning nozzle are provided similarly to those of the first embodiment, although not shown.

### INDUSTRIAL APPLICABILITY

According to the invention, it is possible to provide an inexpensive slow filtration device with no maintenance requirement, capable of starting operation in a short time after being newly assembled, and efficiently purifying raw water over a long period of time, and the practical value of the device is high.

### REFERENCE NUMBER LIST

10: SLOW FILTRATION DEVICE
11: PURIFYING CONTAINER (FILTRATION TANK)
11C: LID
12: REMOVAL PART
13: FILTRATION SAND LAYER
14: RAW-WATER SUPPLY PART
15: NET
16: ALGAE RAISING LAMP
18: HEAT-GENERATING HEATER
19: ROTARY SHAFT
22: DRIVING MOTOR
24: HORIZONTAL ARM
25: SUCTION NOZZLE
26: SEALED BOX
27: DISCHARGE PIPE
28: PUMP
30: REVERSE CLEANING NOZZLE
51: FIRST RAIL
52: SECOND RAIL
54: DISCHARGE PIPE

1. A slow filtration device having excellent ability to treat microorganisms including
a filtration sand layer provided within a filtration tank to treat raw water with microorganisms and filter impurities,
a raw-water supply part provided above the filtration sand layer to receive raw water and supply raw water to the filtration sand layer, and
a removal part provided below the filtration sand layer to take out filtered water;
wherein the slow filtration device comprising:
a net (15) provided above the filtration sand layer (13) within the filtration tank (11) to cover the filtration sand layer (13), and used as a carrier for the raising and breeding of algae;
a heat-generating heater (18) provided directly below the net (15) to maintain the net (15) at a predetermined temperature; and
an algae raising lamp (16) provided above the net (15) within the filtration tank (11) to radiate light onto the net (15) to promote growth and breeding of the algae.

2. The slow filtration device having excellent ability to treat microorganisms according to claim 1, further comprising an aeration pipe (34) attached to the filtration tank (11), and blowing raw water containing air into the raw-water supply part to aerate the raw water.

3. The slow filtration device having excellent ability to treat microorganisms according to claim 1, further comprising:
a reverse cleaning nozzle (20) provided at the bottom of the filtration tank (11) to pump reverse cleaning water towards the filtration sand layer (13) to allow excess sludge and filtrate adhered to the filtration sand layer (13) and the net (15) to gush up;
a sludge discharge device which sucks the excess sludge and filtrate which have gushed up by a plurality of suction nozzles (25) and discharges the excess sludge and filtrate from discharge passages (19, 24, 26, 27); and
a driving mechanism which moves the suction nozzles (25) along the surface of the net (15) directly above the net (15).

4. The slow filtration device having excellent ability to treat microorganisms apparatus for excellent microorganism treatment according to claim 2,
wherein the filtration tank (11) has a cylindrical shape,
the driving mechanism is adapted such that a rotary shaft (19) is provided at the center of the filtration tank (11) so as to vertically extend, the plurality of suction nozzles (25) is attached to a horizontal arm (24) at intervals in a longitudinal direction, a base of the horizontal arm (24) is fixed to the rotary shaft (19), and the rotary shaft (19) is rotated by a driving source (22).

5. The slow filtration device having excellent ability to treat microorganisms according to claim 2,
wherein the filtration tank (11′) has a quadrangular box shape, and
the driving mechanism includes a first rail (51) provided horizontally above the filtration tank (11′), a second rail (52) horizontally supported by the first rail (51) so as to be slidable along the first rail (51) and extending in a direction orthogonal to the first rail (51), and a draining pipe (54) supported by the second rail (52) so as to be slidable along the second rail (52), extending vertically downward, and having suction nozzles (25) attached to a lower end thereof.

6. The slow filtration device having excellent ability to treat microorganisms according to claim 1,
wherein the net (15) is manufactured as a metal net made of stainless steel with openings within a range of 0.053 mm to 0.283 mm.

7. The slow filtration device having excellent ability to treat microorganisms according to claim 1,
wherein the surface layer of the filtration sand layer (13) is composed of fine burnt sand within a range of a mean diameter of 0.08 mm to 0.3 mm.
